(19) United States
(12) Patent Application Publication
(10) Pub. No.: US 2019/0295058 A1
(43) Pub. Date: Sep. 26, 2019

(54) MERCHANDISE PURCHASE SUPPORT SYSTEM, MERCHANDISE PURCHASE SUPPORT METHOD, AND PROGRAM

(71) Applicant: Rakuten, Inc., Tokyo (JP)

(72) Inventors: Hiroshi SHINOHARA, Setagaya-ku, Tokyo (JP); Kikumi KAI, Setagaya-ku, Tokyo (JP); Yoshiro MATSUDA, Setagaya-ku, Tokyo (JP)

(21) Appl. No.: 16/329,219

(22) PCT Filed: Sep. 5, 2016
(86) PCT No.: PCT/JP2016/076031

§ 371 Date: Jun. 3, 2019

(51) Int. Cl. G06Q 20/20; G06Q 30/06; G06Q 20/32

(52) U.S. Cl. CPC G06Q 20/202; G06Q 20/327; G06Q 30/0641

(57) ABSTRACT

Provided is a product purchase assistance system capable of assisting a user in easily grasping a list of products sold by a plurality of vending machines. A product list acquisition unit acquires a list of products sold by a plurality of vending machines within a predetermined range from a mobile terminal. A display control unit performs control for displaying product information on each product included in the list on a display unit of the mobile terminal.

### TECHNICAL FIELD

The present invention relates to a product purchase assistance system, a product purchase assistance method, and a program.

### BACKGROUND ART

There is known a system that uses a mobile terminal to assist in product purchase on a vending machine. For example, in a system described in Patent Literature 1, one vending machine and a mobile terminal are connected by Bluetooth (registered trademark), and a menu of products sold by the vending machine is displayed on a screen of the mobile terminal. This enables a user to select a desired product on the screen of the mobile terminal. Further, for example, in a system described in Patent Literature 2, when a user designates on a screen of a mobile terminal a product he or she wishes to purchase, vending machines selling the product the user wishes to purchase are retrieved, and stock information and position information on the retrieved vending machines are displayed on the screen of the mobile terminal. As a result, the user can grasp the vending machines having stock of the product the user wishes to purchase, and purchase the product he or she wishes to purchase from a vending machine.

### CITATION LIST

### Patent Literature

[PTL 1] JP 2003-518304 A

[PTL 2] JP 2003-217008 A

### SUMMARY OF INVENTION

### Technical Problem

However, in the related-art systems, the assistance for enabling the user to easily grasp a list of the products sold by a plurality of vending machines has been insufficient. For example, in the system described in Patent Literature 1, in order to grasp a list of the products sold by a plurality of vending machines, the user is required to confirm the product menu of each vending machine one by one. Further, for example, in the system described in Patent Literature 2, the user can grasp the vending machine selling a product the user wishes to purchase by designating the product he or she wishes to purchase, but in order to acquire a list of the products sold by a plurality of vending machines, the user is required to repeat the designation of the product (product user wishes to purchase) and retrieval of the vending machines. The user cannot designate an unknown product as the product he or she wishes to purchase in the first place, and thus, with the system described in Patent Literature 2, it is also difficult to grasp unknown products sold by a plurality of vending machines.

The present invention has been made in view of the above-mentioned problems. It is an object of the present invention to provide a product purchase assistance system, a product purchase assistance method, and a program, which are capable of assisting a user in easily grasping a list of products sold by a plurality of vending machines.

### Solution to Problem

In order to solve the above-mentioned problems, a product purchase assistance system according to one embodiment of the present invention is a product purchase assistance system configured to assist in purchase of a product sold by a vending machine, and includes: acquisition means for acquiring a list of products sold by a plurality of vending machines within a predetermined range from a mobile terminal; and display control means for performing control for displaying product information on each product included in the list on display means of the mobile terminal.

Further, a product purchase assistance method according to one embodiment of the present invention is a product purchase assistance method for assisting in purchase of a product sold by a vending machine, and includes: an acquisition step of acquiring, by acquisition means, a list of products sold by a plurality of vending machines within a predetermined range from a mobile terminal; and a display control step of performing, by display control means, control for displaying product information on each product included in the list on display means of the mobile terminal.

Further, a program according to one embodiment of the present invention is a program for causing a computer to function as: acquisition means for acquiring a list of products sold by a plurality of vending machines within a predetermined range from a mobile terminal; and display control means for performing control for displaying product information on each product included in the list on display means of the mobile terminal.

Further, an information storage medium according to one embodiment of the present invention is a computer-readable information storage medium having the above-mentioned program recorded thereon.

Further, in one aspect of the present invention, the mobile terminal may include short-range wireless communication means for performing short-range wireless communication, and the acquisition means may be configured to acquire, from each of a plurality of vending machines within a communicable short-range wireless communication range from the mobile terminal, a list of the products sold by the each of plurality of vending machines, via the short-range wireless communication.

Further, in one aspect of the present invention, the mobile terminal may include: selection operation reception means for receiving a selection operation of selecting as a purchase product at least one product included in the list; and purchase processing request means for requesting execution of purchase processing of purchasing the at least one product selected as the purchase product, and the product purchase assistance system may further include notification means for notifying a user of a purchase product provision machine, which is a vending machine from among the plurality of vending machines that is to dispense and provide to the user the at least one product selected as the purchase product.

Further, in one aspect of the present invention, the notification means may be configured to notify the user of the purchase product provision machine by displaying on the display means a guidance screen guiding to a position of the purchase product provision machine.

Further, in one aspect of the present invention, the acquisition means may be configured to acquire a list of products sold by a plurality of vending machines within a predetermined first range from the mobile terminal, and the selection operation reception means may be configured to receive the selection operation of selecting as the purchase product a product sold by one of the plurality of vending machines when the one of the plurality of vending machines is within a second predetermined range narrower than the predetermined first range from the mobile terminal.

Further, in one aspect of the present invention, the product purchase assistance system may further include: proximity determination means for determining whether the mobile terminal is in proximity to the purchase product provision machine; and provision control means for performing, when it is determined that the mobile terminal is in proximity to the purchase product provision machine after completion of the purchase processing, control for causing the purchase product provision machine to dispense the at least one product selected as the purchase product.

Further, in one aspect of the present invention, the selection operation reception means may include: first selection operation reception means for receiving a first selection operation of selecting as a purchase candidate at least one product included in the list; and second selection operation reception means for receiving a second selection operation of selecting the at least one product selected as the purchase candidate as a product to be purchased, and the product purchase assistance system may further include selection information acquisition means for acquiring selection information on the selection of the purchase candidate and the selection of the product to be purchased.

Further, in one aspect of the present invention, the display control means may be configured to perform, when the same product is sold by a plurality of vending machines, control for displaying on the display means the product information on the same product under a state in which the same product sold by each of the plurality of vending machines is aggregated as one product.

Further, in one aspect of the present invention, the acquisition means may include means for acquiring stock information on stock of products in each of the plurality of vending machines, and the display control means may include means for setting, based on the stock information, a display priority of the product information on each product included in the list.

### Advantageous Effects of Invention

According to the embodiments of the present invention, it is possible to assist a user in easily grasping a list of products sold by a plurality of vending machines.

### BRIEF DESCRIPTION OF DRAWINGS

FIG. 1 is a diagram for illustrating an example of a configuration of a product purchase assistance system according to an embodiment of the present invention.

FIG. 2 is a diagram for illustrating an example of a product list screen.

FIG. 3 is a diagram for illustrating another example of the product list screen.

FIG. 4 is a diagram for illustrating an example of a purchase screen.

FIG. 5 is a diagram for illustrating an example of a guidance screen.

FIG. 6 is a function block diagram for illustrating an example of functions to be implemented by the product purchase assistance system.

FIG. 7 is a diagram for showing an example of a vending machine table.

FIG. 8 is a diagram for showing an example of a product-for-sale table.

FIG. 9 is a flowchart for illustrating an example of processing to be executed by the product purchase assistance system.

FIG. 10 is a flowchart for illustrating an example of other processing to be executed by the product purchase assistance system.

FIG. 11 is a diagram for showing another example of the vending machine table.

FIG. 12 is a diagram for showing another example of the product-for-sale table.

FIG. 13 is a flowchart for illustrating an example of other processing to be executed by the product purchase assistance system.

FIG. 14 is a diagram for illustrating modification examples of the present invention.

### DESCRIPTION OF EMBODIMENTS

Now, exemplary embodiments of the present invention are described in detail with reference to the drawings.

### 1. First Embodiment

Firstly, a first embodiment of the present invention is described.

[1-1. System Configuration]

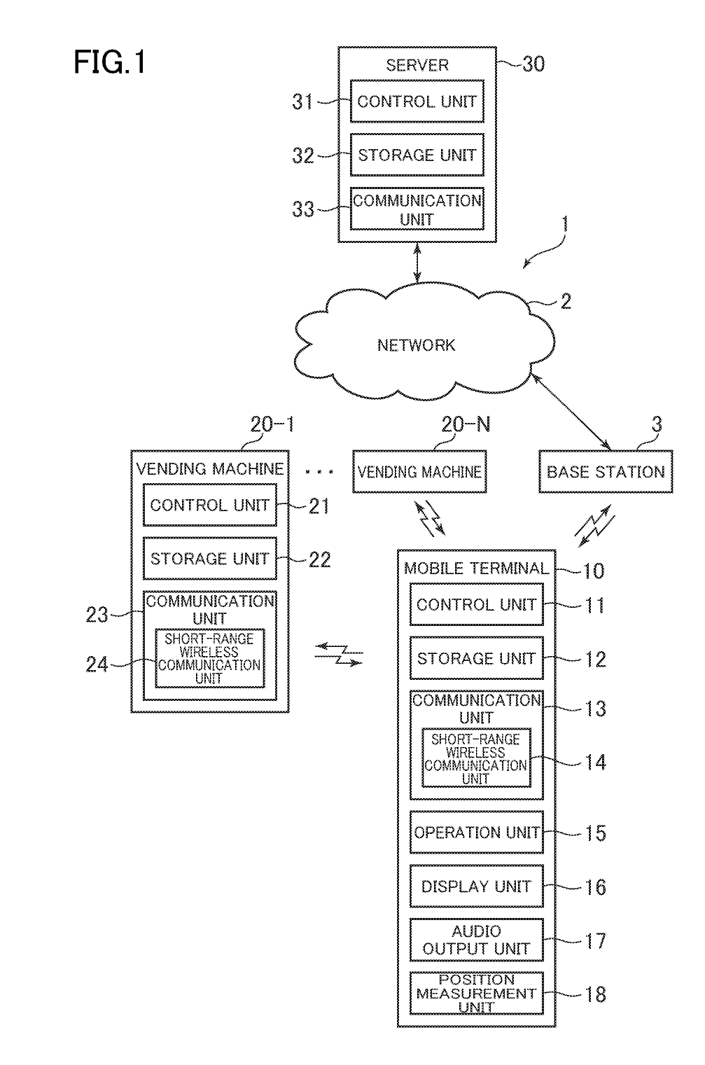

FIG. 1 is a diagram for illustrating an example of a configuration of a product purchase assistance system according to the first embodiment of the present invention. A product purchase assistance system 1 is a system for assisting in purchase of a product sold by a vending machine. As illustrated in FIG. 1, the product purchase assistance system 1 includes a mobile terminal 10, a plurality of vending machines 20-1 to 20-N, and a server 30.

The mobile terminal 10 is a mobile information processing device to be used by a user. For example, the mobile terminal 10 is a cell phone (including smartphone) or a tablet computer. As illustrated in FIG. 1, the mobile terminal 10 includes a control unit 11, a storage unit 12, a communication unit 13, an operation unit 15, a display unit 16, an audio output unit 17, and a position measurement unit 18.

The control unit 11 includes one or a plurality of microprocessors, and executes information processing in accordance with a program stored in the storage unit 12. The storage unit 12 includes a main storage unit (e.g., RAM) and an auxiliary storage unit (e.g., ROM, hard disk drive, and solid state drive), and stores programs to be executed by the control unit 11. The storage unit 12 also operates as a work memory of the control unit 11.

The communication unit 13 is a unit for communication via a network 2, for example, the Internet. For example, the communication unit 13 has a function for wirelessly communication to and from a base station 3. The mobile terminal 10 is connected to the network 2 via the base station 3. The communication unit 13 includes a short-range wireless communication unit 14 for performing short-range wireless communication. The short-range wireless communication unit 14 includes a communication interface for performing short-range wireless communication in accordance with a standard, for example, Bluetooth and wireless LAN. Therefore, the mobile terminal 10 can directly communicate via short-range wireless communication to and from a device (e.g., vending machine 20) that is within a communicable short-range wireless communication range.

The operation unit 15 is used by the user to perform an operation. The display unit 16 is, for example, a liquid crystal display unit or an organic EL display unit, and displays various screens in accordance with instructions from the control unit 11. In FIG. 1, the operation unit 15 and the display unit 16 are illustrated separately, but the operation unit 15 and the display unit 16 may also be integrally configured as a so-called touch panel. In this case, the user can perform various operations by touching the touch panel with, for example, a finger or a touch pen. It is not always required to integrally configure the operation unit 15 and the display unit 16 as a touch panel, and the operation unit 15 may be an operation element arranged separately from the display unit 16, such as a button, a key, or a lever (stick).

The audio output unit 17 is, for example, a speaker or headphones, and outputs various kinds of audio in accordance with instructions from the control unit 11. The position measurement unit 18 is a unit for measuring the position of the mobile terminal 10. For example, the position measurement unit 18 receives a signal transmitted from each of a plurality of GPS satellites and measures the position of the mobile terminal 10 based on those signals.

The programs and data are supplied to the storage unit 12 via the network 2. The mobile terminal 10 may include a component (e.g., optical disc drive unit or memory card slot unit) for reading out a program or data stored on an information storage medium (e.g., optical disc or memory card). The programs and data may also be supplied to the storage unit 12 via the information storage medium.

The vending machines 20-1, . . . , 20-N are each a vending machine for selling one or a plurality of products (e.g., beverages or foods). The products sold by one vending machine may be different from the products sold by another vending machine, or a part or all of the products may be the same. In the following, the vending machines 20-1, . . . , 20-N are collectively referred to as “vending machine 20”.

As illustrated in FIG. 1, the vending machine 20 includes a control unit 21, a storage unit 22, and a communication unit 23. The communication unit 23 includes a short-range wireless communication unit 24. Those units are the same as the control unit 11, the storage unit 12, the communication unit 13, and the short-range wireless communication unit 14 of the mobile terminal 10. The vending machine 20 may also include the same operation unit, display unit, and audio output unit as the operation unit 15, the display unit 16, and the audio output unit 17.

The server 30 is used to manage the vending machine 20 and to execute purchase processing (payment processing) for products. As illustrated FIG. 1, the server 30 includes a control unit 31, a storage unit 32, and a communication unit 33. The control unit 31 and the storage unit 32 are the same as the control unit 11 and the storage unit 12 of the mobile terminal 10. The communication unit 33 is a unit for communication via the network 2. For example, the communication unit 33 includes a wired communication interface, and the server 30 is connected to the network 2 via the wired communication interface. The communication unit 33 may also include a wireless communication interface, and the server 30 may be connected to the network 2 via the wireless communication interface.

The server 30 may include a component (e.g., optical disc drive unit or memory card slot unit) for reading out a program or data stored on an information storage medium (e.g., optical disc or memory card). The programs and data may be supplied to the storage unit 32 via the information storage medium. The programs and data may also be supplied to the storage unit 32 via the network 2.

The mobile terminal 10 and the server 30 can communicate to and from each other via the network 2. The vending machine 20 may also be connected to the network 2 via, for example, the base station 3 so that the vending machine 20 can communicate to and from the server 30 via the network 2.

[1-2. Outline of Functions]

With the product purchase assistance system 1, the user can grasp a list of all the products sold by a plurality of vending machines 20 near the user, and can purchase a desired product from among the list. There is now described a procedure to be performed by the user.

First, the user performs a predetermined operation for requesting display of the product list. When the operation is performed, a vending machine 20 within a predetermined range from the mobile terminal 10 is identified, and a list of the products sold by that vending machine 20 is displayed on the display unit 16. At this time, when there are a plurality of vending machines 20 within the above-mentioned range, a plurality of vending machines 20 are identified, and a list of the products sold by each of the plurality of vending machines 20 is displayed on the display unit 16.

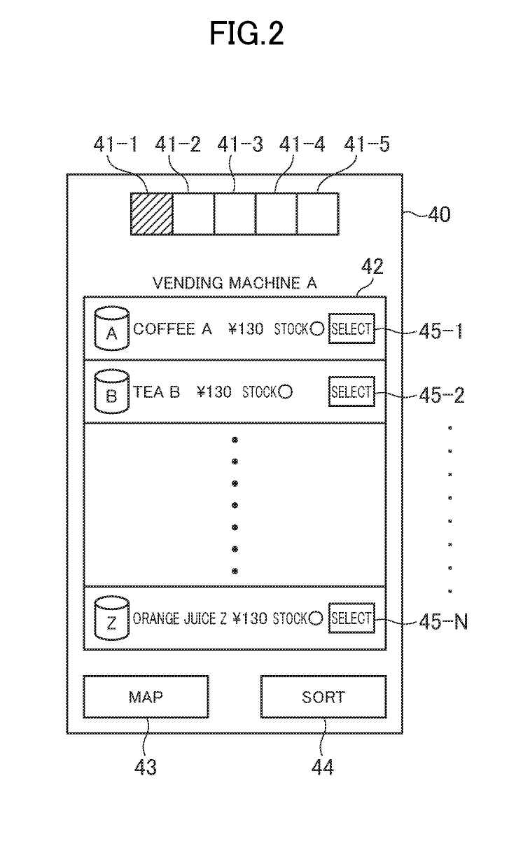

FIG. 2 is a diagram for illustrating an example of a product list screen displayed on the display unit 16. In FIG. 2, there is illustrated in case in which there are five vending machines 20 (in this example, denoted as “vending machine A, B, C, D, and E”) within the predetermined range from the mobile terminal 10.

On a product list screen 40 illustrated in FIG. 2, five vending machine buttons 41-1, 41-2, 41-3, 41-4, and 41-5 are displayed. Those five vending machine buttons 41-1 to 41-5 correspond to the five vending machines A to E within the predetermined range from the mobile terminal 10, respectively, and are buttons for selecting any one of the vending machines A to E.

In FIG. 2, the vending machine button 41-1 corresponding to the vending machine A is selected. In this state, the name of the vending machine A is displayed above a list region 42, and a list of the products sold by the vending machine A is displayed in the list region 42. The list region 42 displays an image, a name, a price, and a stock status of each product. Regarding the stock status, a circle mark is displayed when the stock is sufficiently large, a triangle mark is displayed when the stock is low, and a cross mark is displayed when there is no stock available. The stock quantity itself may also be displayed.

When the user selects the vending machine button 41-2 (e.g., when vending machine button 41-2 is tapped), the vending machine B corresponding to the vending machine button 41-2 is selected, and the list of the products sold by the vending machine B is displayed in the list region 42. The same applies for the other vending machine buttons 41-3, 41-4, and 41-5. In this way, the product list screen 40 displays a list of the products sold by each of the vending machines A to E. In the following, the vending machine buttons 41-1 to 41-5 may be collectively referred to as “vending machine button 41”.

The vending machine 20 may also be selected by a sliding operation or a flick operation in the lateral direction. For example, in a state in which the vending machine B is selected (state in which vending machine button 41-2 is selected), when a sliding operation or a flick operation to the left is performed, the vending machine C may be selected, and when a sliding operation or a flick operation to the right is performed, the vending machine A may be selected.

A map button 43 is displayed on the product list screen 40. For example, when the user selects the map button 43 under the state illustrated in FIG. 2, a map for showing the position of the currently selected vending machine A is displayed on the display unit 16.

A sort button 44 is displayed on the product list screen 40. The sort button 44 is a button for sorting the products displayed in the list region 42. The user can sort the products displayed in the list region 42, for example, in descending order of stock quantity (or in ascending order of price, for example) by selecting the sort button 44.

Selection buttons 45-1, 45-2, . . . , 45-N are displayed on the product list screen 40. The selection buttons 45-1, 45-2, . . . , 45-N are displayed in association with the products displayed in the list region 42, and are used to select one of the products displayed in the list region 42. For example, the selection button 45-1 is displayed in association with “coffee A”, and is a button for selecting “coffee A”. In the following, the selection buttons 45-1 to 45-N may be collectively referred to as “selection button 45”.

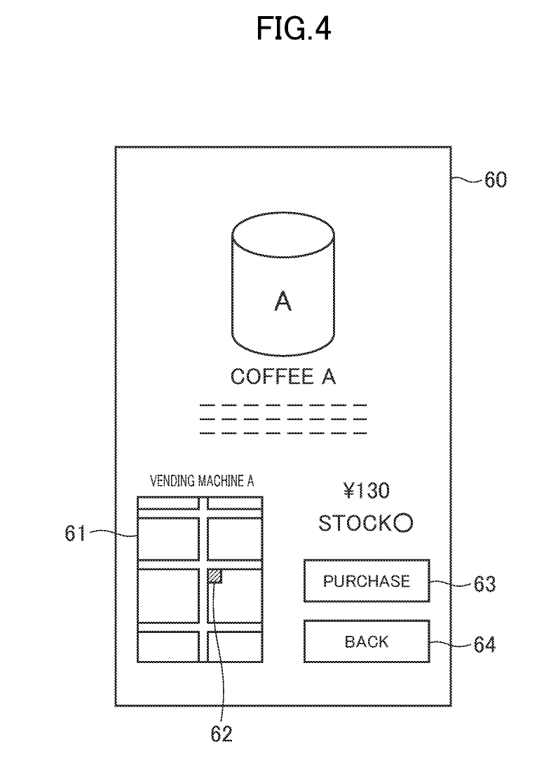

First, on the product list screen 40, the user selects the vending machine 20 selling a desired product. When the desired product is sold by a plurality of vending machines 20, the user relies on the map to select one of the vending machines 20. For example, the user selects a vending machine 20 closest to his or her current position or a vending machine 20 in a destination direction. Next, the user selects a desired product from among the products displayed in the list region 42 by selecting one of the selection buttons 45. When a product is selected, a purchase screen for purchasing that product from the currently selected vending machine 20 is displayed on the display unit 16. For example, when the user selects the selection button 45-1 under the state illustrated in FIG. 2, the purchase screen for purchasing “coffee A” from the vending machine A is displayed (see FIG. 4 described later).

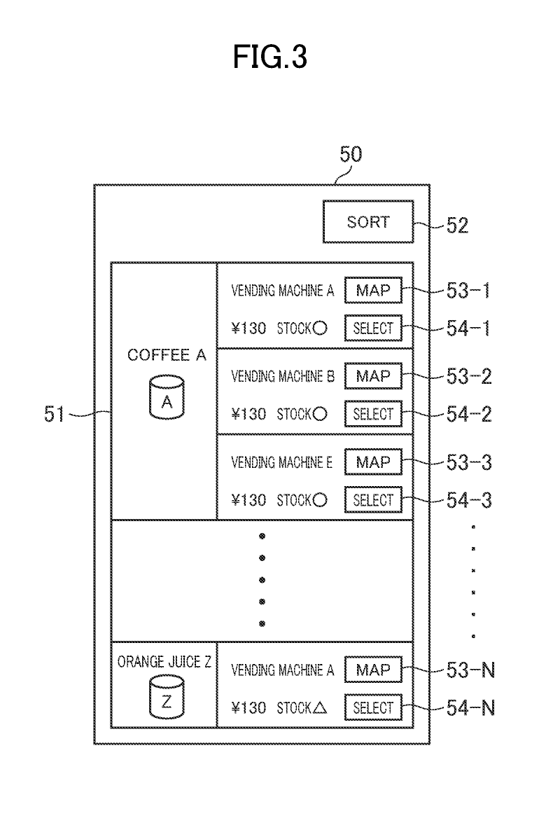

FIG. 3 is a diagram for illustrating another example of the product list screen. In FIG. 3 as well, there is illustrated a case in which there are five vending machines 20 (vending machines A to E) within a predetermined range from the mobile terminal 10. The product list screen 50 illustrated in FIG. 3 may be displayed in place of the product list screen 40 illustrated in FIG. 2, or the user may be allowed to freely switch between the product list screen 40 and the product list screen 50.

A list of the products sold by the vending machines A to E is displayed in a list region 51 of the product list screen 50. When the same product is sold by a plurality of vending machines 20, that same product sold by the plurality of vending machines 20 is aggregated and displayed in the list region 51 as one product. In FIG. 3, there is illustrated a case in which “coffee A” is sold by the three vending machines A, B and E. In FIG. 3, the name and image of “coffee A” are aggregated as one product, and information on the three vending machines A, B, and E (price or stock status of “coffee A”) is displayed in association with the single aggregated name and image.

A sort button 52 is displayed on the product list screen 50. The sort button 52 is a button for sorting the information on the vending machines 20 displayed in association with each product. The user can sort the information on the three vending machines A, B and E displayed in association with “coffee A” in order of proximity from the mobile terminal 10 (or in descending order of stock number or in ascending order of price, for example) by selecting the sort button 52.

Map buttons 53-1, 53-2, 53-3, . . . , 53-N are displayed on the product list screen 50. Among them, the map buttons 53-1, 53-2, and 53-3 are displayed in association with the vending machines A, B, and E that sell “coffee A”, respectively. When the user selects map button 53-1, a map for showing the position of the vending machine A is displayed. Similarly, when the user selects the map button 53-2 or 53-3, a map for showing the position of the vending machine B or E is displayed. In the following, the map buttons 53-1 to 53-N may be collectively referred to as “map button 53”.

Selection buttons 54-1, 54-2, 54-3, . . . , 54-N are displayed on the product list screen 50. Among them, the selection buttons 54-1, 54-2, and 54-3 are displayed in association with the vending machines A, B, and E that sell “coffee A”, respectively. The selection buttons 54-1 to 54-3 are buttons for selecting one of the vending machines 20 for purchasing “coffee A”. A user wishing to purchase “coffee A” selects a vending machine 20 to purchase “coffee A” by selecting one of the selection buttons 54-1 to 54-3. For example, when the user selects the selection button 54-1, the purchase screen for purchasing “coffee A” from the vending machine A is displayed (see FIG. 4 described later). In the following, the selection buttons 54-1 to 54-N may be collectively referred to as “selection button 54”.

FIG. 4 is a diagram for illustrating an example of a purchase screen for purchasing a product. A purchase screen 60 illustrated in FIG. 4 is a screen for purchasing “coffee A” from the vending machine A. Therefore, on the purchase screen 60 illustrated in FIG. 4, an image, a name, a description (e.g., tagline or advertisement), a price, and a stock status of “coffee A” are displayed.

A map 61 for showing the position of the vending machine A is also displayed on the purchase screen 60. A mark 62 indicating the position of the vending machine A is displayed on the map 61. Text indicating the position of the vending machine A may also be displayed. For example, there may be displayed text indicating the position of the vending machine A in terms of a relative positional relationship with a place serving as a landmark, such as “Vending machine is arranged next to . . . .”

The purchase screen 60 includes a purchase button 63 and a back button 64. When the user selects the back button 64, the product list screen 40 or 50 is displayed on the display unit 16. Meanwhile, when the user selects the purchase button 63, “coffee A” purchase processing (payment processing) is executed.

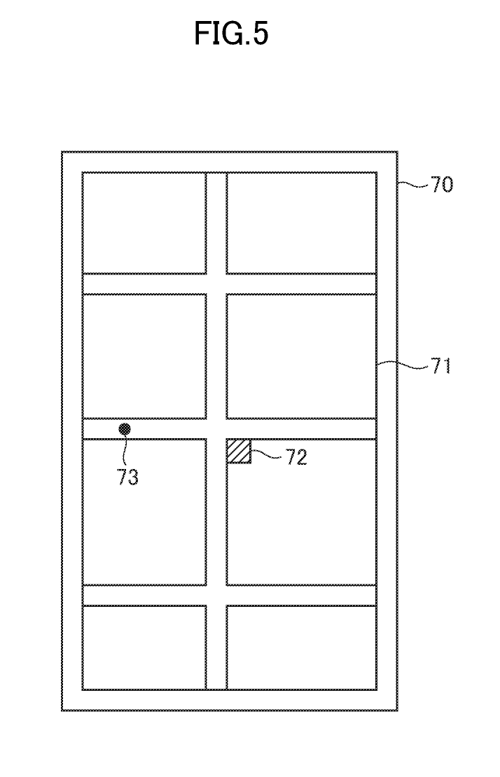

After completion of the purchase processing, a guidance screen guiding to the position of the vending machine A is displayed on the display unit 16, and the user is again notified of the position of the vending machine A. FIG. 5 is a diagram for illustrating an example of the guidance screen. In FIG. 5, a map 71 is displayed on the guidance screen 70. On the map 71, a mark 72 indicating the position of the vending machine A and a mark 73 indicating the current position of the mobile terminal 10 are displayed.

The user is guided by the guidance screen 70 to the front of the vending machine A. When the user has proceeded to the front of the vending machine A, “coffee A” is dispensed to a product dispensing port of the vending machine A, and the user can receive “coffee A”.

In this way, with the product purchase assistance system 1, the user can use the mobile terminal 10 to grasp a list of all products sold by a plurality of vending machines 20 in the vicinity of the user, and purchase a desired product from the list.

[1-3. Function Blocks]

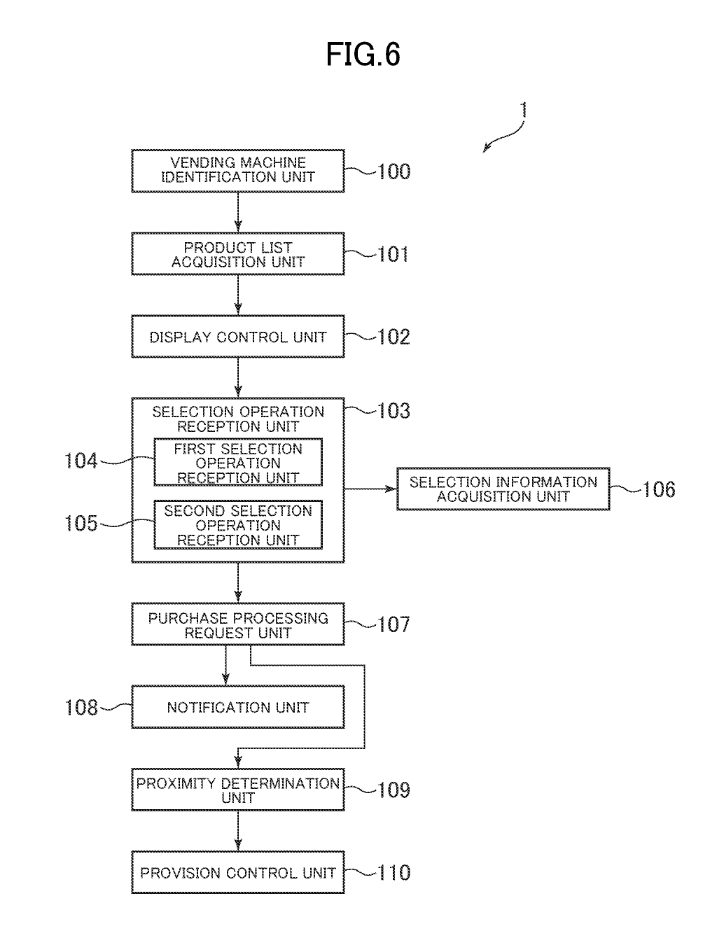

Next, there is described a configuration for implementing the above-mentioned functions. FIG. 6 is a function block diagram for illustrating function blocks to be implemented by the product purchase assistance system 1. As illustrated in FIG. 6, the product purchase assistance system 1 includes a vending machine identification unit 100, a product list acquisition unit 101 (acquisition means), a display control unit 102 (display control means), a selection operation reception unit 103 (selection operation reception means), a selection information acquisition unit 106 (selection information acquisition means), a purchase processing request unit 107 (purchase processing request means), a notification unit 108 (notification means), a proximity determination unit 109 (proximity determination means), and a provision control unit 110 (provision control means).

For example, each function block illustrated in FIG. 6 is implemented by the mobile terminal 10. In the following, there is mainly described a case in which each function block illustrated in FIG. 6 is implemented by the mobile terminal 10, but a part or all of the function blocks illustrated in FIG. 6 may be implemented by a device other than the mobile terminal 10. Specific examples are described later.

[1-3-1] The vending machine identification unit 100 identifies a vending machine 20 that is within a predetermined range from the mobile terminal 10.

For example, the vending machine identification unit 100 identifies a vending machine 20 that is within a communicable short-range wireless communication range (example of predetermined range) from the mobile terminal 10 by the short-range wireless communication unit 14. There is described here an example in which Bluetooth is used for the short-range wireless communication, but short-range wireless communication other than Bluetooth (e.g., wireless LAN or IrDA) may also be used.

The vending machine identification unit 100 performs a device detection procedure in accordance with the Bluetooth standard to detect devices capable of communicating by Bluetooth to and from the mobile terminal 10. The vending machine identification unit 100 also determines whether or not the detected device is a vending machine 20. When a plurality of vending machines 20 are included among the detected devices, the vending machine identification unit 100 identifies a plurality of vending machines 20. For the vending machines 20 thus identified, address information required for performing Bluetooth communication is acquired from those vending machines 20 and stored in the storage unit 12 of the mobile terminal 10.

[1-3-2] The product list acquisition unit 101 acquires a list of the products sold by the plurality of vending machines 20 that are within a predetermined range from the mobile terminal 10.

For example, the product list acquisition unit 101 acquires a list of the products sold by each of the plurality of vending machines 20 that are within a predetermined range from the mobile terminal 10. Specifically, the product list acquisition unit 101 acquires, from each of a plurality of vending machines 20 within a communicable short-range wireless communication range from the mobile terminal 10 by the short-range wireless communication unit 14, a list of the products sold by those vending machines 20 via short-range wireless communication.

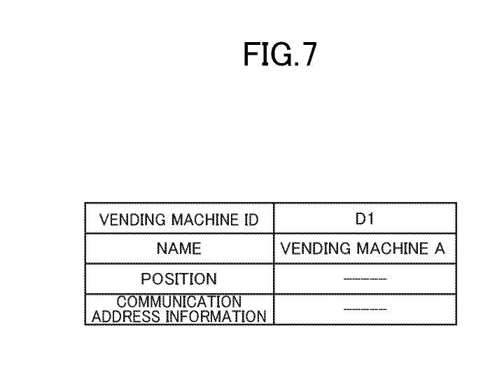

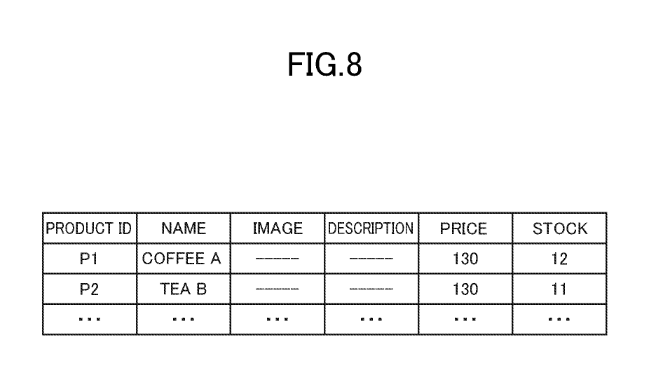

Information on each of the vending machines 20 is stored in the storage unit 22 of the vending machine 20. FIG. 7 and FIG. 8 are tables for showing an example of the information stored in the storage unit 22 of each vending machine 20.

FIG. 7 is a diagram for showing an example of a vending machine table. As shown in FIG. 7, the vending machine table includes a “vending machine ID” field, a “name” field, a “position” field, and a “communication address information” field. The “vending machine ID” field indicates information for uniquely identifying each vending machine 20. The “name” and “position” fields indicate the name and the position of the vending machine 20. For example, the latitude/longitude or the installation place address of the vending machine 20 is registered in the “position” field. The “communication address information” field indicates communication address information (e.g., Bluetooth address and IP address) of the vending machine 20.

FIG. 8 is a diagram for showing an example of a product-for-sale table. The product-for-sale table shows a list of the products sold by the vending machines 20. As shown in FIG. 8, the product-for-sale table includes a “product ID” field, a “name” field, an “image” field, a “description” field, a “price” field, and a “stock” field. The “product ID” field indicates information for uniquely identifying each product. For the same product, even when the product is sold by different vending machines 20, the product ID is the same. The “name”, “image”, “description”, “price”, and “stock” fields indicate the name, image, description, price, and stock information (e.g., stock quantity) of the product. The stock information stored in the “stock” field is updated each time the product is purchased. The stock information on the product is also provided to the company administering the vending machine. The person administering the vending machine can identify by how much the stock of the product has been reduced from the stock information of the product, and issue an instruction for the product to be refilled and the like.

The product list acquisition unit 101 communicates directly to and from each vending machine 20 identified by the vending machine identification unit 100 via short-range wireless communication to acquire the above-mentioned information from each of those vending machines 20. Specifically, the product list acquisition unit 101 issues a request to each vending machine 20 to transmit the above-mentioned information and to acquire the above-mentioned information returned from each of the corresponding vending machines 20 in response to the request. The product list acquisition unit 101 stores the acquired name, position information, and product-for-sale information on each vending machine 20 in the storage unit 12 in association with the vending machine ID.

[1-3-3] The display control unit 102 performs control for displaying on the display unit 16 product information on each product included in the list acquired by the product list acquisition unit 101.

For example, the display control unit 102 performs control for displaying on the display unit 16 the product information on each product included in the list acquired by the product list acquisition unit 101 in association with identification information that enables the user to identify the vending machine that is selling the product. The “identification information” is, for example, the position information, name, or vending machine ID of the vending machines 20. Specifically, the display control unit 102 displays on the display unit 16 the product list screen 40 or 50 illustrated in FIG. 2 or FIG. 3. On the product list screen 40, when the map button 43 or the selection button 45 is selected, the position information on the vending machines 20 selling the products displayed in the list region 42 is displayed. On the product list screen 50 as well, when the map button 53 or the selection button 54 is selected, the position information on the vending machines 20 selling the products displayed in the list region 51 is displayed. Therefore, on the product list screen 40 or 50, the name, image, price, and stock status (example of product information) of the products sold by the vending machines 20 are displayed in association with the position information (example of identification information) on the vending machines 20. On the product list screen 40 or 50, the name and the like of the products (example of product information) are displayed in association with the name of the vending machines (example of identification information).

The display control unit 102 may set a display priority of the products displayed in the list region 42 or 51 of the product list screen 40 or 50 based on the stock information on the products. For example, the display control unit 102 may set the display priority of the products such that the display priority (sort order) of a product is higher when the stock quantity of the product is larger.

[1-3-4] The selection operation reception unit 103 receives a selection operation of selecting as a purchase product at least one product included in the list acquired by the product list acquisition unit 101. As illustrated in FIG. 6, the selection operation reception unit 103 includes a first selection operation reception unit 104 and a second selection operation reception unit 105.

The first selection operation reception unit 104 receives a first selection operation of selecting as a purchase candidate at least one product included in the list.

For example, the first selection operation reception unit 104 receives an operation (example of first selection operation) of selecting any one of the selection buttons 45 displayed on the product list screen 40. When one of the selection buttons 45 has been selected, the first selection operation reception unit 104 determines that the product associated with the selected selection button 45 has been selected as a “purchase candidate”. For example, when the selection button 45-1 has been selected under the state illustrated in FIG. 2, the first selection operation reception unit 104 determines that “coffee A” has been selected as the purchase candidate.

For example, the first selection operation reception unit 104 receives an operation (example of first selection operation) of selecting any one of the selection buttons 54 displayed on the product list screen 50. When one of the selection buttons 54 has been selected, the first selection operation reception unit 104 determines that the product associated with the selected selection button 54 has been selected as a “purchase candidate”. For example, when the selection button 54-1 has been selected under the state illustrated in FIG. 3, the first selection operation reception unit 104 determines that “coffee A” has been selected as the purchase candidate.

The second selection operation reception unit 105 receives a second selection operation of selecting as the purchase product the product selected as the purchase candidate. For example, the second selection operation reception unit 105 receives an operation of selecting the purchase button 63 of the purchase screen 60 (example of second selection operation). When the purchase button 63 has been selected, the second selection operation reception unit 105 determines that the product displayed on the purchase screen 60 has been selected as the “purchase product”.

[1-3-5] The selection information acquisition unit 106 acquires selection information on the selection of the purchase candidate and the selection of the purchase product. For example, the selection information acquisition unit 106 acquires, as the selection information, information indicating that a product selected on the product list screen 40 or 50 but not purchased on the purchase screen 60 (i.e., product selected as purchase candidate but not selected as purchase product), or information indicating a product purchased in place of that product, which has not been purchased. For example, the selection information acquired by the selection information acquisition unit 106 is transmitted to the server 30 and stored in the storage unit 32. A history of the selection information may be temporarily stored in the storage unit 12, and at a predetermined timing (e.g., when purchase product is determined or product purchase is canceled (state in which there has been no input from user continues for predetermined period of time, for example), the history of the selection information stored in the storage unit 12 may be transmitted from the mobile terminal 10 to the server 30 and stored in the storage unit 32, or the selection information may be transmitted from the mobile terminal 10 to the server 30 each time the back button 64 of the purchase screen 60 is selected or each time the purchase button 63 is selected, and the history of the selection information may be stored in the storage unit 32.

The selection information stored in the storage unit 32 is used for marketing, or is provided to the providing company (manufacturer) of the product or to the operating company of the vending machine. For example, the ratio of the number of times “coffee A” is selected as a purchase candidate but not finally purchased to the number of times “coffee A” is selected as a purchase candidate may be calculated, and when the ratio is a predetermined value or more, the providing company or the like of “coffee A” may be urged to review its description (e.g., advertisement) of “coffee A” displayed on the purchase screen 60 or to change “coffee A” to another product. As another example, the ratio of the number of times “coffee A” is finally purchased to the number of times “coffee A” is selected as the purchase candidate may be calculated, and when the ratio is a predetermined value or less, the above-mentioned review or change may be suggested to the providing company or the like of “coffee A”.

[1-3-6] The purchase processing request unit 107 requests execution of purchase processing of purchasing the product selected as the purchase product. For example, the purchase processing request unit 107 transmits via the communication unit 13 a purchase processing execution request to another device (e.g., server 30) capable of executing the purchase processing.

[1-3-7] The notification unit 108 notifies the user of a purchase product provision machine from among the plurality of vending machines identified by the vending machine identification unit 100. The “purchase product provision machine” herein is the vending machine 20 to dispense and provide to the user the product selected as the purchase product. For example, when the purchase button 63 of the purchase screen 60 in the state illustrated in FIG. 4 has been selected, the vending machine A corresponds to the “purchase product provision machine”.

For example, the notification unit 108 notifies the user of the purchase product provision machine by displaying on the display unit 16 a guidance screen guiding to the position of the purchase product provision machine. Specifically, the notification unit 108 displays on the display unit 16 the guidance screen 70 illustrated in FIG. 5.

[1-3-8] The proximity determination unit 109 determines whether or not the mobile terminal 10 is in proximity to the purchase product provision machine.

For example, the proximity determination unit 109 determines whether or not a strength of a radio signal transmitted from the purchase product provision machine and received by the mobile terminal 10 is equal to or more than a threshold value. Specifically, the proximity determination unit 109 determines whether or not the strength of the short-range wireless communication signal (e.g., Bluetooth signal or wireless LAN signal) transmitted from the purchase product provision machine and received by the mobile terminal 10 is equal to or more than a threshold value. When the strength is equal to or more than the threshold value, the proximity determination unit 109 determines that the mobile terminal 10 is in proximity to the purchase product provision machine. Meanwhile, when the strength is not equal to or more than the threshold value, the proximity determination unit 109 determines that the mobile terminal 10 is not in proximity to the purchase product provision machine.

A transmission unit configured to transmit a weak radio wave (beacon) that can only reach the surroundings of the vending machine 20 may also be included in the vending machine 20, and the proximity determination unit 109 may determine whether or not the radio wave (beacon) transmitted from the transmission unit of the purchase product provision machine is received by the terminal 10. When the radio wave is received by the mobile terminal 10, the proximity determination unit 109 may determine that the mobile terminal 10 is in proximity to the purchase product provision machine, and when the radio wave is not received by the mobile terminal 10, the proximity determination unit 109 may determine that the mobile terminal 10 is not in proximity to the purchase product provision machine.

The proximity determination unit 109 may also calculate a distance between the mobile terminal 10 and the purchase product provision machine based on the position of the mobile terminal 10 acquired by the position measurement unit 18 and the position of the purchase product provision machine acquired from the purchase product provision machine, and determine whether the distance is equal to or less than a threshold value. When the distance is equal to or less than the threshold value, the proximity determination unit 109 may determine that the mobile terminal 10 is in proximity to the purchase product provision machine, and when the distance is not equal to or less than the threshold value, the proximity determination unit 109 may determine that the mobile terminal 10 is not in proximity to the purchase product provision machine.

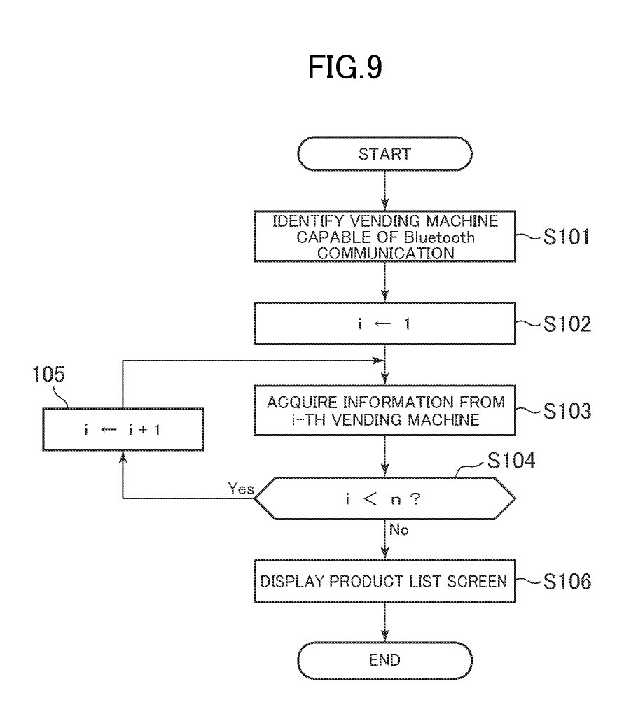

A code image (e.g., two-dimensional barcode) unique to the vending machine 20 may be attached to the outer surface of the housing of the vending machine 20, and the code image may be read (captured) by the user using the mobile terminal 10 after completion of the purchase processing. The proximity determination unit 109 may determine whether or not the read code image is the code image of a purchase product provision machine. For example, the proximity determination unit 109 may determine whether or not a vending machine ID indicated by the read code image is the vending machine ID of the purchase product provision machine. When the read code image is the code image of the purchase product provision machine, the proximity determination unit 109 may determine that the mobile terminal 10 is in proximity to the purchase product provision machine.

[1-3-9] The provision control unit 110 performs, when it is determined that the mobile terminal 10 is in proximity to the purchase product provision machine after completion of the purchase processing, control for causing the purchase product provision machine to provide the product selected as the purchase product. For example, the provision control unit 110 issues, via short-range wireless communication, a purchase product provision request to the purchase product provision machine. The “purchase product provision request” herein is a request that the purchase product be dispensed from the product dispensing port. When the request is received by the purchase product provision machine, control for dispensing the purchase product to the product dispensing port is performed by the purchase product provision machine, and the purchase product is dispensed to the product dispensing port.

[1-4. Processing] Next, processing to be executed by the purchase assistance system is described.

[1-4-1] FIG. 9 is a flowchart for illustrating an example of processing to be executed by the mobile terminal 10 in order to display the product list screen 40 or 50 on the display unit 16. The control unit 11 of the mobile terminal 10 functions as the vending machine identification unit 100, the product list acquisition unit 101, and the display control unit 102 by executing the processing illustrated in FIG. 9 in accordance with a program.

As illustrated in FIG. 9, first, the control unit 11 identifies a vending machine 20 capable of Bluetooth communication (Step S101). For example, the control unit 11 detects a device capable of communicating by Bluetooth to and from the mobile terminal 10 by performing a device detection procedure in accordance with the Bluetooth standard, and determines whether or not the detected device is a vending machine 20.

Then, the control unit 11 acquires information in order from each of the vending machines 20 identified in Step S101 (Step S102 to Step S105).

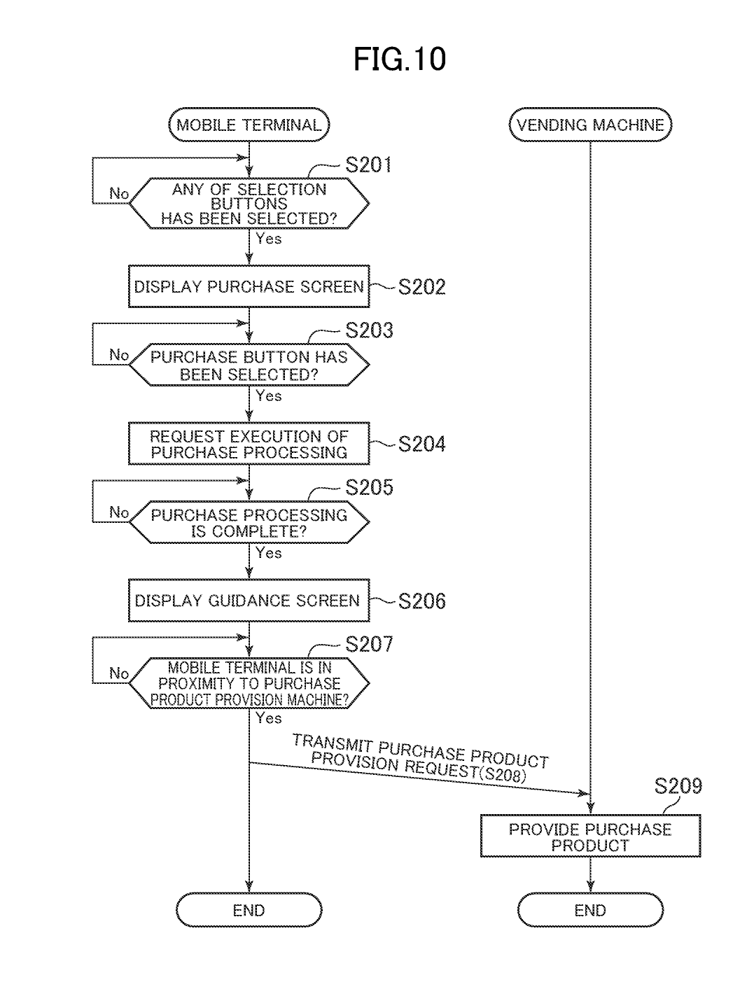

First, the control unit 11 initializes a variable i to 1 (Step S102), and acquires information from the i-th vending machine 20 of the vending machines 20 identified in Step S100 (Step S103). For example, the control unit 11 pairs the mobile terminal 10 with the i-th vending machine 20. Then, the control unit 11 transmits a predetermined request to the i-th vending machine 20 by Bluetooth communication. The “predetermined request” herein is a request to transmit the vending machine table and a sales information table stored in the storage unit 22 to the mobile terminal 10. The control unit 11 acquires the vending machine table and the sales information table transmitted back from the i-th vending machine 20 via Bluetooth communication in response to the request. The vending machine table and the sales information table of each vending machine 20 are stored in the storage unit 12 in association with the vending machine ID, and are used in the subsequent processing and the processing of FIG. 10, which is described later.

After the execution of Step S103, the control unit 11 determines whether or not the variable i is less than n (Step S104). The value “n” is the total number of vending machines 20 identified in Step S101.

The variable i is less than n when the acquisition of information from all the vending machines 20 identified in Step S101 has not been completed. Therefore, in such a case, the control unit 11 adds 1 to the variable i (Step S105), and acquires information from the i-th vending machine 20 of the vending machines 20 identified in Step S101 (Step S103).

Meanwhile, the variable i is not less than n when the acquisition of information from all the vending machines 20 identified in Step S101 is complete. Therefore, in such a case, the control unit 11 displays on the display unit 16 the product list screen 40 or 50 based on the information acquired in Step S103 to Step S105 (Step S106).

[1-4-2] FIG. 10 is a flowchart for illustrating an example of processing to be executed from a state in which the product list screen 40 or 50 is displayed. The control unit 11 of the mobile terminal 10 functions as the selection operation reception unit 103, the purchase processing request unit 107, the notification unit 108, the proximity determination unit 109, and the provision control unit 110 by executing the processing illustrated in FIG. 10 in accordance with a program.

As illustrated in FIG. 10, when the product list screen 40 or 50 is displayed, the control unit 11 monitors whether or not any of the selection buttons 45 or 54 has been selected (Step S201). When any of the selection buttons 45 or 54 has been selected, the control unit 11 displays the purchase screen 60 on the display unit 16 (Step S202).

For example, when any of the selection buttons 45 has been selected on the product list screen 40, the control unit 11 displays on the display unit 16 the purchase screen 60 for purchasing the product corresponding to the selected selection button 45 from the vending machine 20 selected on the product list screen 40. For example, in the state illustrated in FIG. 2, the vending machine A is selected, and the selection button 45-1 is displayed in association with “coffee A”. Thus, when the selection button 45-1 is selected, the control unit 11 displays on the display unit 16 the purchase screen 60 for purchasing “coffee A” from the vending machine A. In this case, “coffee A” is set as the purchase product, and the vending machine A is set as the purchase product provision machine (vending machine 20 providing purchase product). The product ID of “coffee A” and the vending machine ID of the vending machine A are stored in the storage unit 12 as information indicating the purchase product and the purchase product provision machine.

When any of the selection buttons 54 has been selected on the product list screen 50, the control unit 11 displays on the display unit 16 the purchase screen 60 for purchasing the product corresponding to the selected selection button 54 from the vending machine corresponding to that selection button 54. For example, in the state illustrated in FIG. 3, the selection button 54-1 is displayed in association with a combination of “coffee A” and “vending machine A”. Thus, when the selection button 54-1 is selected, the control unit 11 displays on the display unit 16 the purchase screen 60 for purchasing “coffee A” from the vending machine A. In this case as well, “coffee A” is set as the purchase product, and the vending machine A is set as the purchase product provision machine (vending machine 20 providing purchase product). The product ID of “coffee A” and the vending machine ID of the vending machine A are stored in the storage unit 12 as information indicating the purchase product and the purchase product provision machine.

When the product list screen 40 or 50 is displayed, the control unit 11 also monitors whether or not the vending machine buttons 41, the map button 43 or 53, or the sort button 44 or 52 is selected, and when any one of those buttons has been selected, executes processing of changing the vending machine 20 to be displayed, displaying a map, or executing sorting. However, this processing is not shown in FIG. 10.

When the purchase screen 60 is displayed, the control unit 11 monitors whether or not the purchase button 63 has been selected (Step S203). When the purchase button 63 has been selected, the control unit 11 requests execution of purchase processing (Step S204). Specifically, the control unit 11 transmits a purchase processing execution request to another device (e.g., the server 30) capable of executing the purchase processing (payment processing).

When the purchase screen 60 is displayed, the control unit monitors whether or not the back button 64 has been selected. When the back button 64 has been selected, processing for causing the screen to transition from the purchase screen 60 to the product list screen 40 or 50 is also executed. However, this processing is not shown in FIG. 10.

After the execution of Step S204, the control unit 11 determines whether or not the purchase processing is complete (Step S205). For example, when the above-mentioned another device has executed purchase processing in response to the execution request and the purchase processing is complete, the another device notifies the mobile terminal 10 that the purchase processing is complete. The control unit 11 monitors whether or not the notification has been received, and when the notification is received, determines that the purchase processing is complete.

When the purchase processing is complete, the control unit 11 displays on the display unit 16 the guidance screen 70 guiding to the position of the purchase product provision machine (Step S206). While the guidance screen 70 is displayed, the control unit 11 acquires position information on the mobile terminal 10 every predetermined time period, and updates the position of the mark 73 displayed on the map 71 of the guidance screen 70.

Further, the control unit 11 determines whether or not the mobile terminal 10 is in proximity to the purchase product provision machine (Step S207).

For example, the control unit 11 determines whether or not the strength of the Bluetooth signal transmitted from the purchase product provision machine and received by the mobile terminal 10 is equal to or more than a threshold value. When the strength is equal to or more than the threshold value, the control unit 11 determines that the mobile terminal 10 is in proximity to the purchase product provision machine.

For example, the control unit 11 also calculates the distance between the position of the mobile terminal 10 and the position of the purchase product provision machine, and determines whether or not the distance is equal to or less than a threshold value. When the distance is equal to or less than the threshold value, the control unit 11 determines that the mobile terminal 10 is in proximity to the purchase product provision machine.

When the mobile terminal 10 is determined to be in proximity to the purchase product provision machine, the control unit 11 transmits a purchase product provision request to the purchase product provision machine via Bluetooth communication (Step S208). For example, the product ID of the purchase product is transmitted to the purchase product provision machine.

When the purchase product provision request is received by the purchase product provision machine, the control unit 21 of the purchase product provision machine provides the purchase product (Step S209). Specifically, the control unit 21 dispenses the purchase product to the dispensing port by controlling a product discharge mechanism.

[1-5. Summary] According to the product purchase assistance system 1 described above, the user can use the mobile terminal 10 to grasp a list of the products sold by a plurality of vending machines 20 in the vicinity of the user. As a result, the user is not required to go in front of each vending machine 20 in order to confirm the products sold by each of those vending machines 20. The user can also select a purchase product from among the products sold by a plurality of vending machines 20 in the vicinity of the user. For this reason, for example, it is less likely that the user subsequently finds a more preferred product than the purchase product to regret his or her product purchase. The user can also select an unknown product as the purchase product.

With the product purchase assistance system 1, a list of the products sold by the vending machines 20 is acquired by communication between the mobile terminal 10 and the vending machines 20, and thus the user is not required to search for products, which enables user's time and effort to be reduced.

With the product purchase assistance system 1, a list of the products sold by the vending machines 20 in the vicinity of the mobile terminal 10 is acquired by performing short-range wireless communication between the mobile terminal 10 and the vending machine 20, and thus the user can obtain a list of products that the user can go and buy in a short time. With the product purchase assistance system 1, the vending machines from which the product list is acquired is limited to the vending machines 20 within a relatively narrow range, and it is not required to acquire the product list from many vending machines 20 within a wide range. As a result, an increase in the processing load on the system can be suppressed.

With the product purchase assistance system 1, the stock status of the products is displayed on the product list screens 40 and 50, and thus the user can also grasp the stock status of the products in each vending machine 20. As a result, for example, the user can avoid a situation in which he or she goes in front of a vending machine 20 to find that there is no stock of the product.

On the product list screen 50, the same product sold by a plurality of vending machines 20 is displayed in a state aggregated as one product, which enables display space to be saved. In general, the display region on the mobile terminal 10 is small, but more information can be displayed on one screen by saving display space in the manner described above. Displaying the same product sold by a plurality of vending machines 20 in a state aggregated as one product enables the user to easily select the product. In the case of the product list screen 50, the user can easily select which vending machine 20 to purchase the desired product from.

With the product purchase assistance system 1, the guidance screen 70 as illustrated in FIG. 7 is displayed. As a result, the user can easily grasp from which vending machine 20 the purchase product is to be dispensed.

With the product purchase assistance system 1, when the user (mobile terminal 10) has moved to be in proximity to the purchase product provision machine, the purchase product is dispensed by the purchase product provision machine. If the purchase product is dispensed when the user is not in proximity to the purchase product provision machine, another person may take the purchase product of the user. However, with the product purchase assistance system 1, the likelihood of an occurrence of such inconvenience is reduced.

The product purchase assistance system 1 includes the selection information acquisition unit 106. As a result, for example, information on a product selected as a purchase candidate but not finally purchased can be obtained, and such information can be used for marketing or provided to the providing company (manufacturer) of the product or to the operating company of the vending machine.

With the product purchase assistance system 1, the same product may be sold by a plurality of vending machines. For this reason, information on which vending machine among the plurality of vending machines selling the same product has been selected as the purchase place of the product may be acquired and stored. For example, history information on which product of which vending machine the user has checked (i.e., which product of which vending machine is selected by user as purchase candidate) when a vending machine and a product are to be selected on the mobile terminal 10 may be stored. The history information may be stored in the storage unit 32 by transmitting information on the products displayed on the purchase screen 60 (i.e., products checked by the user) as purchase candidates to the server 30 from the mobile terminal 10 each time the purchase screen 60 is displayed, or history information on the products displayed on the purchase screen 60 as purchase candidates may be temporarily stored in the storage unit 12, and at a predetermined timing (e.g., when purchase product is determined or product purchase is canceled (state in which there has been no input from user continues for predetermined period of time, for example)), the history information may be stored in the storage unit 32 by transmitting the history information stored in the storage unit 12 from the mobile terminal 10 to the server 30.

For example, in the example illustrated in FIG. 3, “coffee A” is sold by three vending machines A, B, and E. In this situation, when “coffee A” is purchased at the vending machine E, information indicating that the vending machine E has been selected as the purchase place of “coffee A” and that the vending machines A and B are not selected may be acquired and stored. For example, when the user browsed the purchase screen 60 of “coffee A” sold by the vending machine A, the purchase screen 60 of “coffee A” sold by the vending machine B, and the purchase screen 60 of “coffee A” sold by the vending machine E, compared each of those purchase screens 60, and finally purchased the “coffee A” of the vending machine E by selecting the purchase button 63 of the purchase screen 60 of “coffee A” of the vending machine E, browsing history information indicating that the user browsed each of the purchase screen 60 of “coffee A” sold by the vending machine A, the purchase screen 60 of “coffee A” sold by the vending machine B, and the purchase screen 60 of “coffee A” sold by the vending machine E, and purchase result information indicating that “coffee A” of the vending machine E has been finally purchased may also be stored.

Such information can be used for marketing or provided to the providing company (manufacturer) of the product or to the operating company of the vending machine.

For example, based on the information stored in the manner described above, a ratio of the number of times the product is not purchased at the vending machine A and is purchased at another vending machine to the number of times the vending machine A is compared with the other vending machines as the vending machine selling the same product may be calculated. When the ratio is equal to or more than a predetermined value, the providing company or the like of the product may be urged to review the product lineup, the installation place, or the like of the vending machine A. The ratio of the number of times the product is purchased at the vending machine A and not purchased at another vending machine to the number of times of the above-mentioned comparison is performed may be calculated, and when the ratio is equal to or less than a predetermined value, the above-mentioned review may be suggested to the operating company or the like of the vending machine A.

For example, there may be acquired information on the position or region in which display of the product list of the vending machine A is requested or in which the product of the vending machine A is purchased, and information on the distance from the vending machine A to the mobile terminal 10 at the point in time at which display of the product list of the vending machine A is requested or at which the product of the vending machine A is purchased. Such information may be linked and analyzed with a “history of the product not being purchased at the vending machine A but is purchased at another vending machine as a result of the user comparing the vending machine A with other vending machines” or a “history of the product being purchased at the vending machine A but not purchased at another vending machine as a result of the user comparing the vending machine A with other vending machines”. Based on that analysis, estimations may be performed regarding, for example, what number of users from which place considered purchasing the product at the vending machine A, and whether or not users who considered purchasing the product from a given place tended to finally select the vending machine A as a result of comparing the vending machines. Those estimation results may be provided to the operating company or the like of the vending machine A.

### 2. Second Embodiment

Next, a second embodiment of the present invention is described.

The product purchase assistance system 1 according to the second embodiment includes the same configuration as that of the first embodiment (see FIG. 1). In the product purchase assistance system 1 according to the second embodiment, a screen similar to that of the first embodiment is displayed on the display unit 16 of the mobile terminal 10 (see FIG. 2 to FIG. 5). In the product purchase assistance system 1 according to the second embodiment, function blocks similar to those of the first embodiment are implemented (see FIG. 6).

In the first embodiment, the mobile terminal 10 is configured to identify the vending machines 20 within a predetermined range from the mobile terminal 10 and acquire information from those vending machines 20 by directly communicating to and from the vending machines 20 via short-range wireless communication (e.g., Bluetooth communication). Meanwhile, in the second embodiment, the server 30 is configured to identify the vending machines 20 within a predetermined range from the mobile terminal 10 and acquire information from those vending machines 20. In the following, differences between the second embodiment and the first embodiment are described.

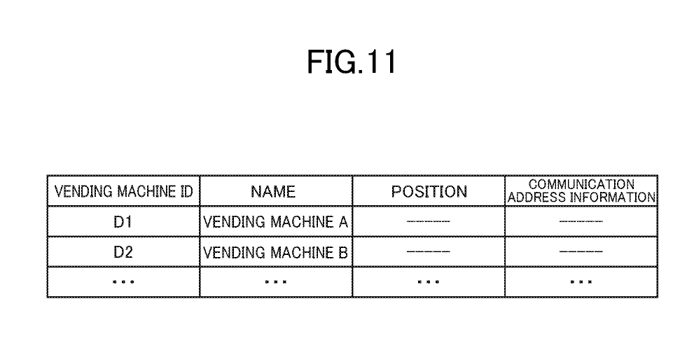

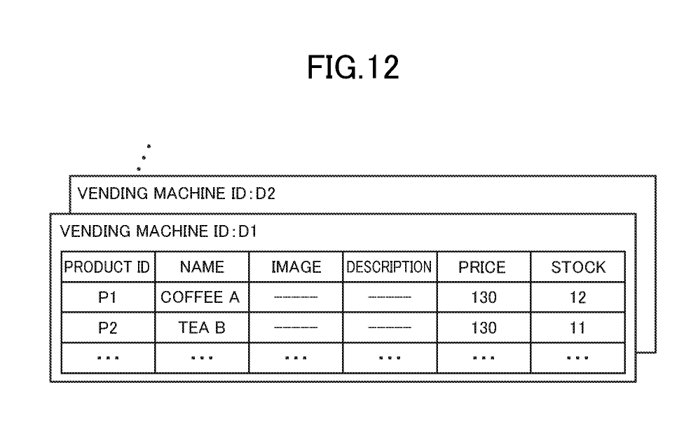

In the product purchase assistance system 1 according to the second embodiment, information on the vending machines 20 arranged at various places is stored in the storage unit 32 of the server 30. FIG. 11 and FIG. 12 are tables for showing an example of the information stored in the storage unit 32. The information may also be stored in another storage device accessible from the server 30.

FIG. 11 is a diagram for showing an example of a vending machine table. In the vending machine table, a list of the vending machines 20 is shown. The vending machine table shown in FIG. 11 corresponds to a table for showing all of the vending machine tables stored in the storage units 22 of the respective vending machines 20 in the first embodiment.

FIG. 12 is a table for showing an example of a product-for-sale table. A product-for-sale table is stored for each vending machine 20 (stored in association with vending machine ID), and information on products sold by the vending machine 20 is shown in the table. The product-for-sale table shown in FIG. 12 is similar to the product-for-sale table stored in the storage unit 22 of each vending machine 20 in the first embodiment. Specifically, in the second embodiment, the product-for-sale table stored in the storage unit 22 of each vending machine 20 in the first embodiment is stored centrally in the storage unit 32 of the server 30.

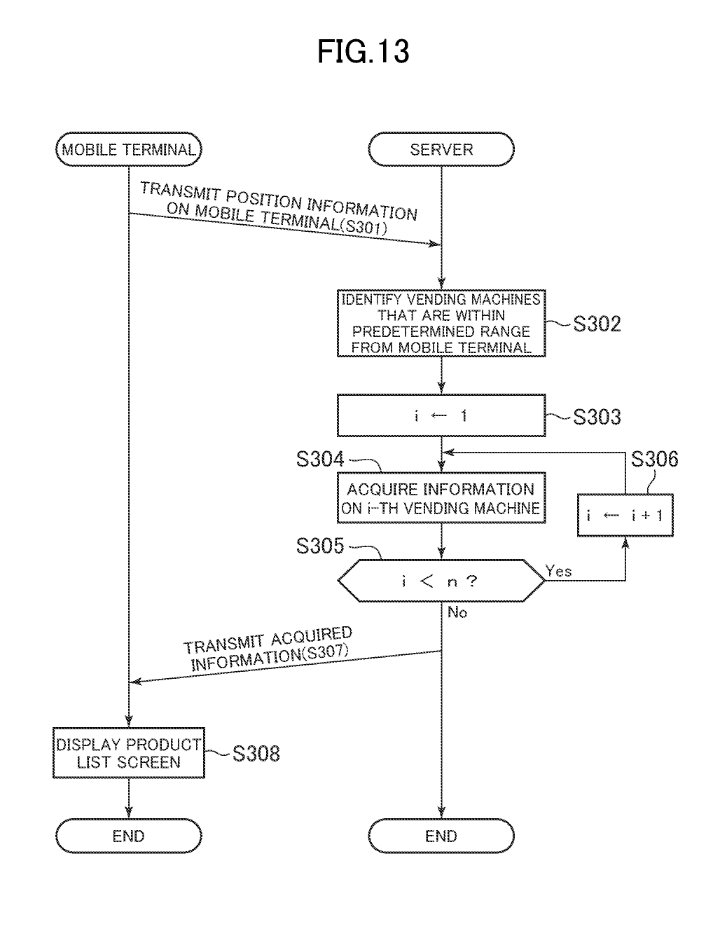

FIG. 13 is a flowchart for illustrating an example of processing to be executed by the product purchase assistance system 1 according to the second embodiment. FIG. 13 is an illustration of processing to be executed in order to display the product list screen 40 or 50 on the display unit 16. This processing is executed in place of the processing of FIG. 9.

As illustrated in FIG. 11, first, the control unit 11 of the mobile terminal 10 transmits to the server 30 the position information on the mobile terminal 10 (Step S301). When the position information is received by the server 30, the control unit 31 of the server 30 identifies the vending machines 20 that are within a predetermined range from the mobile terminal 10 (Step S302). For example, the control unit 31 refers to the vending machine table, and identifies the vending machines 20 within a range in which a distance from the mobile terminal 10 is equal to or less than a predetermined distance.

After the execution of Step S302, the control unit 11 acquires information on each vending machine 20 identified in Step S302 (Step S303 to Step S306).

First, the control unit 11 initializes a variable i to 1 (Step S303), and acquires, from the vending machine table and the product-for-sale table, information on the i-th vending machine 20 of the vending machines 20 identified in Step S302 (Step S304). For example, the control unit 11 acquires the name and position information on the i-th vending machine 20 from the vending machine table, and acquires information (product ID, name, image, price, and stock) on the products sold by the i-th vending machine 20 from the product-for-sale table of the i-th vending machine 20.

After the execution of Step S304, the control unit 11 determines whether or not the variable i is less than n (Step S305). The value “n” is the total number of vending machines 20 identified in Step S302.

The variable i is less than n when the acquisition of information from all the vending machines 20 identified in step S302 has not been completed. Therefore, in this case, the control unit 11 adds 1 to the variable i (Step S306), and acquires, from the vending machine table and the product-for-sale table, the information on the i-th vending machine 20 of the vending machines 20 identified in Step S302 (Step S304).

Meanwhile, the variable i is not less than n when the acquisition of information from all the vending machines 20 identified in Step S302 is complete. Therefore, in this case, the control unit 11 displays, on the display unit 16 of the mobile terminal 10, the product list screen 40 or 50 by transmitting the information acquired in Step S304 to Step S306 to the mobile terminal 10 (Step S307). In the mobile terminal 10 that has received this information, the product list screen 40 or 50 is displayed on the display unit 16 based on the received information (Step S308).

In the second embodiment, the vending machine identification unit 100, the product list acquisition unit 101, and the display control unit 102 are implemented by the control unit 31 of the server 30 executing the above-mentioned processing. As a result, in the second embodiment, the vending machine identification unit 100, the product list acquisition unit 101, and the display control unit 102 are implemented by the control unit 31 of the server 30.

With the product purchase assistance system 1 according to the second embodiment as well, the user can use the mobile terminal 10 to grasp a list of all the products sold by a plurality of vending machines 20 in the vicinity of the user.

### 3. Modification Examples

The present invention is not limited to the first embodiment and the second embodiments described above.

[3-1] In the first embodiment, the vending machine identification unit 100 may be implemented by the server 30.

For example, in this modification example, similarly to the second embodiment, the same vending machine table as that of FIG. 11 is stored in the storage unit 32. Similarly to in the second embodiment, the mobile terminal 10 transmits position information on itself to the server 30. The control unit 31 (vending machine identification unit 100) of the server 30 refers to the vending machine table, and identifies the vending machines 20 within a predetermined range from the mobile terminal 10. In this case, the vending machine ID and communication address information (e.g., IP address) of each identified vending machine 20 are transmitted back to the mobile terminal 10. The control unit 11 (product list acquisition unit 101) of the mobile terminal 10 acquires information from each identified vending machine 20 via the network 2 based on the information transmitted back from the server 30.

[3-2] In the first embodiment, the information on the products sold by the vending machines 20 may be acquired from the server 30.

For example, in this modification example, similarly to second embodiment, the same product-for-sale table as that of FIG. 12 is stored in the storage unit 32 of the server 30. The product list acquisition unit 101 does not acquire the information on the products sold by each vending machine 20 identified by the vending machine identification unit 100 from those vending machines 20, but rather acquires that information from the server 30. For example, the product list acquisition unit 101 acquires from the server 30 information on the products sold by each vending machine 20 by transmitting the vending machine ID of each vending machine 20 identified by the vending machine identification unit 100 to the server 30.

[3-3] In the first embodiment and the second embodiment, the notification unit 108 may be implemented by a vending machine 20 (purchase product provision machine).

For example, in this modification example, after completion of the purchase processing, the control unit 11 of the mobile 10 notifies the purchase product provision machine of the completion of the purchase processing. The device (e.g., server 30) that has executed the purchase processing may notify the purchase product provision machine of the completion of the purchase processing. The control unit 21 (notification unit 108) of the purchase product provision machine then notifies the user of the position of the purchase product provision machine by displaying a message on the display unit of the purchase product provision machine, by outputting audio from the audio output unit of the purchase product provision machine, or by lighting up a light of the purchase product provision machine.

[3-4] In the first embodiment and the second embodiment, the proximity determination unit 109 and the provision control unit 110 may be implemented by the vending machine 20 (purchase product provision machine).

For example, in this modification example, after the completion of the purchase processing, a device (e.g., server 30) that has executed the purchase processing generates a code (e.g., reservation number or one-time password) required by the user to receive the purchase product, and transmits the code to the mobile terminal 10 and also transmits the code and the product ID of the purchase product to the purchase product provision machine. The control unit 21 (proximity determination unit 109) of the purchase product provision machine receives input of the code from the user via an operation unit (e.g., touch panel) of the purchase product provision machine, and determines whether or not the code input by the user matches a code notified in advance. When those codes match, the control unit 21 (proximity determination unit 109 and provision control unit 110) determines that the mobile terminal 10 is in proximity to the purchase product provision machine, and controls the product discharge mechanism to dispense the purchase product to the dispensing port.

In this modification example, a code updated every predetermined time period may be displayed on the display of the vending machine 20, and the user may be prompted to input into the mobile terminal 10 the code displayed on the display unit of the purchase product provision machine. In this case, the mobile terminal 10 transmits the input code to the purchase product provision machine via short-range wireless communication along with the product ID of the purchase product. Then, the control unit 21 (proximity determination unit 109) of the purchase product provision machine determines whether or not the code displayed on the display unit matches the code received from the mobile terminal 10. When those codes match, the control unit 21 (proximity determination unit 109 and provision control unit 110) determines that the mobile terminal 10 is in proximity to the purchase product provision machine, and controls the product discharge mechanism to dispense the purchase product to the dispensing port.

[3-5] In the first embodiment and the second embodiment, the notification unit 108 may be implemented by the server 30.

For example, in this modification example, the product ID of the purchase product and the vending machine ID of the purchase product provision machine are transmitted to the server 30. The control unit 31 (notification unit 108) of the server 30 displays the guidance screen 70 on the display unit 16 of the mobile terminal 10 by transmitting position information and the like on the purchase product provision machine to the mobile terminal 10.

[3-6] In the first embodiment and the second embodiment, the proximity determination unit 109 may be implemented by the server 30.

For example, in this modification example, based on position information on the mobile terminal 10 repeatedly transmitted from the mobile terminal 10 after completion of the purchase processing, the control unit 31 (proximity determination unit 109) of the server 30 determines whether or not the distance between the mobile terminal 10 and the purchase product provision machine has become equal to or less than a threshold value. When the distance has become equal to or less than the threshold value, the control unit 31 (proximity determination unit 109) determines that the mobile terminal 10 is in proximity to the purchase product provision machine.

In this modification example, a code image (e.g., two-dimensional bar code) unique to the vending machine 20 may be attached to the outer surface of the housing of the vending machine 20, and the code image may be read (captured) by the user using the mobile terminal 10 after completion of the purchase processing. Then, the control unit 11 of the mobile terminal 10 transmits to the server 30 a vending machine ID indicated by the read code image, and the control unit 31 (proximity determination unit 109) of the server 30 determines whether or not the vending machine ID transmitted from the mobile terminal 10 is the vending machine ID of the purchasing product provision machine. When the vending machine ID transmitted from the mobile terminal 10 is the vending machine ID of the purchase product provision machine, the control unit 31 (proximity determination unit 109) determines that the mobile terminal 10 is in proximity to the purchase product provision machine. The mobile terminal 10 may also transmit the code image itself to the server 30. The control unit 31 (proximity determination unit 109) of the server 30 determines whether or not the code image transmitted from the mobile terminal 10 is the code image of the purchase product provision machine, and when the code image transmitted from the mobile terminal 10 is the code image of the purchase product provision machine, the control unit 31 may determine that the mobile terminal 10 is in proximity to the purchase product provision machine.

[3-7] In the first embodiment and the second embodiment, the provision control unit 110 may be implemented by the server 30.

For example, in this modification example, when the mobile terminal 10 is determined to be in proximity to the purchase product provision machine, the control unit 31 (provision control unit 110) of the server 30 transmits to the purchase product provision machine a purchase product provision request via the network 2.

[3-8] The position of the purchase product provision machine may also be guided on the guidance screen 70 by using augmented reality technology (AR technology) or the like. For example, a camera function of the mobile terminal 10 may be enabled, and a real space image photographed by a lens may be displayed on the guidance screen 70. AR technology may be used to guide to the position of the purchase product provision machine in the real space image. A mark (e.g., arrow) indicating the position of the purchase product provision machine may be displayed in the real space image.

[3-9] For the product purchase assistance system 1, there is assumed a case in which a plurality of users each purchase a product at the same vending machine 20 by using the mobile terminal 10, and the plurality of users come to receive the purchase product from the vending machine 20 at the same time. In order to accurately provide the product to each user even in such a case, the following may be performed.

[3-9-1] First, the purchase product may be dispensed by the purchase product provision machine in order of users of the mobile terminal 10 determined to be in proximity to the purchase product provision machine first.

For example, in a mode of determining whether or not the mobile terminal 10 is in proximity to the purchase product provision machine by determining whether or not the vending machine ID indicated by the code image read by the mobile terminal 10 is the vending machine ID of the purchase product provision machine (or whether or not code image read by mobile terminal 10 is code image of purchase product provision machine), the purchase product may be dispensed by the purchase product provision machine in order of users of the mobile terminal 10 who transmitted the vending machine ID (or code image) to the server 30 first.

As another example, in a mode of determining whether or not the mobile 10 is in proximity to the purchase product provision machine by determining whether or not the distance between the mobile terminal 10 and the purchase product provision machine has become equal to or less than a threshold value, the purchase product may be dispensed by the purchase product provision machine in order of users of the mobile terminal 10 for which the distance to the purchase product provision machine has first become equal to or less than the threshold value.

As yet another example, in a mode of determining whether or not the mobile 10 is in proximity to the purchase product provision machine by determining whether or not a strength of a signal transmitted from the purchase product provision machine and received by the mobile terminal 10 is equal to or more than a threshold value, the purchase product may be dispensed by the purchase product provision machine in order of users of the mobile terminal 10 for which the reception strength of the radio signal has first become equal to or more than the threshold value.

As still yet another example, in a mode of determining whether or not the mobile 10 is in proximity to the purchase product provision machine by determining whether or not a radio wave (beacon) transmitted from the purchase product provision machine is received by the terminal 10, the purchase product may be dispensed by the purchase product provision machine in order of users of the mobile terminal 10 for which the radio wave (beacon) is received first.

[3-9-2] When the purchase product is dispensed to the product dispensing port, information enabling identification of the user who purchased the product may be displayed on the display unit of the purchase product provision machine. For example, a code (e.g., reservation number) may be generated when the purchase processing is complete, the user may be notified of the code, and the code may be displayed on the display unit of the purchase product provision machine when the purchase product is dispensed to the product dispensing port. In this way, through comparing the code notified to the user with the code displayed on the display unit of the purchase product provision machine, the user can grasp whether or not the product dispensed to the product dispensing port is the product purchased by himself or herself.

[3-10] Purchase of the products of the vending machine 20 may be restricted until the user is to some extent in proximity to the vending machine 20.

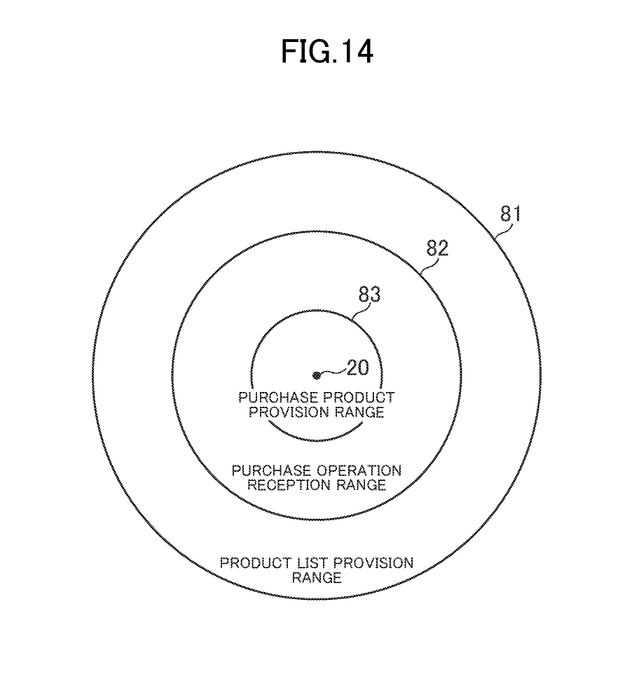

FIG. 14 is a diagram for illustrating this modification example. In FIG. 14, a product list provision range 81, a purchase operation reception range 82, and a purchase product provision range 83 are set around the vending machine 20. Although the product list provision range 81, the purchase operation reception range 82, and the purchase product provision range 83 are illustrated as circular regions in FIG. 14 for convenience, those ranges are not limited to the circular regions.

The product list provision range 81 is a range in which a list of the products sold by the vending machine 20 is provided. Specifically, in this modification example, a list of the products sold by the vending machine 20 is provided to the mobile terminals 10 positioned in the product list provision range 81. Specifically, in this modification example, when a mobile terminal 10 is positioned in the product list provision range 81, the vending machine 20 is identified by the vending machine identification unit 100 as a vending machine 20 within a predetermined range from the mobile terminal 10. As a result, a list of the products sold by the vending machine 20 is acquired by the product list acquisition unit 101 and displayed by the display control unit 102 on the display unit 16 of the mobile terminal 10.

The purchase product provision range 83 is the region closest to the vending machine 20, and is a range in which the mobile terminal 10 is determined to be in proximity to the vending machine 20. Specifically, in this modification example, when the mobile terminal 10 is positioned within the purchase product provision range 83, the proximity determination unit 109 determines that the mobile terminal 10 is in proximity to the vending machine 20, and the provision control unit 110 dispenses the purchase product to the product dispensing port of the vending machine 20 and provided to the user.

The purchase operation reception range 82 is a range for receiving a purchase operation of a product sold by the vending machine 20 (i.e., selection operation of selecting product sold by vending machine 20 as purchase product). The purchase operation reception range 82 is narrower than the product list provision range 81, and is closer to the vending machine 20 than the product list provision range 81. The purchase operation reception range 82 is wider than the purchase product provision range 83, and is a region including the purchase product provision range 83 and a range further away from the vending machine 20 than the purchase product provision range 83.

In this modification example, when the mobile terminal 10 is in the purchase operation reception range 82, the selection operation reception unit 103 receives a selection operation of selecting a product sold by the vending machine 20 as a purchase product. In other words, when the mobile terminal 10 is not in the purchase operation reception range 82, the selection operation reception unit 103 restricts reception of a selection operation of selecting a product sold by the vending machine 20 as a purchase product.

For example, on the purchase screen 60 in the state illustrated in FIG. 4, the purchase button 63 is allowed to be selected only when the mobile terminal 10 is in the purchase operation reception range 82 of the vending machine A (purchase product provision machine). When the mobile terminal 10 is not in the purchase operation reception range 82 of the vending machine A, the purchase button 63 is not allowed to be selected. Specifically, when the mobile terminal 10 is not in the purchase operation reception range 82 of the vending machine A, purchase processing is prevented from being executed by not displaying the purchase button 63, by displaying the purchase button 63 in a non-selectable state (i.e., is grayed out), or by displaying an error message or the like even when the purchase button 63 is selected.

In this way, it is possible to restrict the purchase of the products of a vending machine 20 positioned far away from the user. As a result, it is possible to prevent the user from erroneously purchasing a product of a vending machine 20 positioned far away from the user.

The purchase operation reception range 82 may be the same range as the purchase product provision range 83. Specifically, the selection operation reception unit 103 may receive a selection operation of selecting a product sold by a vending machine 20 as a purchase product when the mobile terminal 10 is in proximity to the vending machine 20. More specifically, the purchase screen 60 in the state illustrated in FIG. 4 may be set such that the purchase button 63 is allowed to be selected only when the mobile terminal 10 is in proximity to the vending machine A (purchase product provision machine), and is not allowed to be selected when the mobile terminal 10 is not in proximity to the vending machine A.

[3-11] After completion of the purchase processing, when the user has not come to the vending machine 20 to receive the purchase product by a predetermined time limit, the product purchase may be canceled and refund processing may be executed.

[3-12] The product purchase function is not a required function. The product purchase assistance system 1 may have only the function for assisting the user in grasping a list of all the products sold by a plurality of vending machines 20 in the vicinity of the user. Specifically, among the function blocks illustrated in FIG. 6, the function blocks other than the vending machine identification unit 100, the product list acquisition unit 101, and the display control unit 102 may be omitted.

### REFERENCE SIGNS LIST

1 product purchase assistance system, 2 network, 3 base station, 10 mobile terminal, 11 control unit, 12 storage unit, 13 communication unit, 14 short-range wireless communication unit, 15 operation unit, 16 display unit, 17 audio output unit, 18 position measurement unit, 20 vending machine, 21 control unit, 22 storage unit, 23 communication unit, 24 short-range wireless communication unit, 30 server, 31 control unit, 32 storage unit, 33 communication unit, 40 product list screen, 41-1, 41-2, 41-3, 41-4, 41-5 vending machine button, 42 list region, 43 map button, 44 sort button, 45-1, 45-2, 45-N selection button, 50 product list screen, 51 list region, 52 sort button, 53-1, 53-2, 53-3, 53-N map button, 54-1, 54-2, 54-3, 54-N selection button, 60 purchase screen, 61 map, 62 mark, 63 purchase button, 64 back button, 70 guidance screen, 71 map, 72, 73 mark, 81 product list provision range, 82 purchase operation reception range, 83 purchase product provision range, 100 vending machine identification unit, 101 product list acquisition unit, 102 display control unit, 103 selection operation reception unit, 104 first selection operation reception unit, 105 second selection operation reception unit, 106 selection information acquisition unit, 107 purchase processing request unit, 108 notification unit, 109 proximity determination unit, 110 provision control unit

The invention claimed is:

1: A product purchase assistance system, which is configured to assist in purchase of a product sold by a vending machine, the product purchase assistance system comprising a server,
wherein the server comprising:
at least one processor; and
at least one memory device that stores a plurality of the server instructions, which when executed by the at least one processor, cause the at least one processor of the server to overate to:
acquire a list of products sold by a plurality of vending machines within a predetermined range from a mobile terminal; and
perform control for displaying product information on each product included in the list on display means of the mobile terminal.

2: The product purchase assistance system according to claim 1, further comprising the mobile terminal,
wherein the mobile terminal comprising:
at least one processor; and
at least one memory device that stores a plurality of the mobile terminal instructions, which when executed by the at least one processor, cause the at least one processor of the mobile terminal to operate to:
perform short-range wireless communication, and
wherein the server instructions cause the at least one processor of the server to operate to acquire, from each of a plurality of vending machines within a communicable short-range wireless communication range from the mobile terminal, a list of the products sold by the each of plurality of vending machines, via the short-range wireless communication.

3: The product purchase assistance system according to claim 1, further comprising the mobile terminal,
wherein the mobile terminal comprising:
at least one processor; and
at least one memory device that stores a plurality of the mobile terminal instructions, which when executed by the at least one processor, cause the at least one processor of the mobile terminal to operate to:
receive a selection operation of selecting as a purchase product at least one product included in the list; and
request execution of purchase processing of purchasing the at least one product selected as the purchase product, and
wherein the server instructions further cause the at least one processor of the server to operate to notify a user of a purchase product provision machine, which is a vending machine from among the plurality of vending machines that is to dispense and provide to the user the at least one product selected as the purchase product.

4: The product purchase assistance system according to claim 3,
wherein the server instructions cause the at least one processor of the server to operate to notify the user of the purchase product provision machine by displaying on the display means a guidance screen guiding to a position of the purchase product provision machine.

5: The product purchase assistance system according to claim 3,
wherein the server instructions cause the at least one processor of the server to operate to acquire a list of products sold by a plurality of vending machines within a predetermined first range from the mobile terminal, and
wherein the mobile terminal instructions cause the at least one processor of the mobile terminal to operate to receive the selection operation of selecting as the purchase product a product sold by one of the plurality of vending machines when the one of the plurality of vending machines is within a second predetermined range narrower than the predetermined first range from the mobile terminal.

6: The product purchase assistance system according to claim 3,
the mobile terminal instructions further cause the at least one processor of the mobile terminal to operate to determine whether the mobile terminal is in proximity to the purchase product provision machine; and
the server instructions further cause the at least one processor of the server to operate to perform when it is determined that the mobile terminal is in proximity to the purchase product provision machine after completion of the purchase processing, control for causing the purchase product provision machine to dispense the at least one product selected as the purchase product.

7: The product purchase assistance system according to claim 3,
wherein the mobile terminal instructions cause the at least one processor of the mobile terminal to overate to:
receive a first selection operation of selecting as a purchase candidate at least one product included in the list; and
receive a second selection operation of selecting the at least one product selected as the purchase candidate as a product to be purchased, and
wherein the server instructions further cause the at least one processor of the server to operate to acquire selection information on the selection of the purchase candidate and the selection of the product to be purchased.

8: The product purchase assistance system according to claim 1,
wherein the server instructions cause the at least one processor of the server to operate to perform, when the same product is sold by a plurality of vending machines, control for displaying on the display means the product information on the same product under a state in which the same product sold by each of the plurality of vending machines is aggregated as one product.

9: The product purchase assistance system according to claim 1,
wherein the server instructions cause the at least one processor of the server to operate to acquire stock information on stock of products in each of the plurality of vending machines, and
wherein the server instructions cause the at least one processor of the server to operate to set, based on the stock information, a display priority of the product information on each product included in the list.

10: A product purchase assistance method for assisting in purchase of a product sold by a vending machine, the product purchase assistance method comprising:
a server, wherein the server comprising:
at least one processor; and
at least one memory device that stores a plurality of the server instructions, which when executed by the at least one processor, cause the at least one processor of the server to operate to:
acquire a list of products sold by a plurality of vending machines within a predetermined range from a mobile terminal; and
perform control for displaying product information on each product included in the list on display means of the mobile terminal.

11: A non-transitory computer readable storage medium storing a plurality of server instructions, wherein when executed by at least one processor, the plurality of the server instructions cause the at least one processor of the server to:
acquire a list of products sold by a plurality of vending machines within a predetermined range from a mobile terminal; and
perform control for displaying product information on each product included in the list on display means of the mobile terminal.
